(19) United States
(12) Patent Application Publication
(10) Pub. No.: US 2011/0077061 A1
(43) Pub. Date: Mar. 31, 2011

(54) CELL PHONE OR PDA COMPACT CASE

(75) Inventors: ALEX DANZE, RIVERSIDE, CA (US); JOSEPH DAVID ARELLANO, MURRIETA, CA (US)

(73) Assignee: ALEX DANZE, RIVERSIDE, CA (US)

(21) Appl. No.: 12/964,583

(22) Filed: Dec. 9, 2010

Related U.S. Application Data
(63) Continuation-in-part of application No. 29/339,652, filed on Jul. 3, 2009, now Pat. No. D624304.
(60) Provisional application No. 61/289,591, filed on Dec. 23, 2009.
(60) Provisional application No. 61/318,665, filed on Mar. 29, 2010.

(51) Int. Cl. H04M 1/00

(52) U.S. Cl. 455/575.1

(57) ABSTRACT

Improvements in a cell phone or PDA case are disclosed. The improvement includes the retention of a cell phone to allow for complete functionality of the phone while it is within the case. The phone is cushioned and protected within the case where it is semi-rigidly held. The case further includes an operable back cover where interchangeable trays can be installed where the trays provide a variety of function such as holding makeup, pills, money, credit cards, key(s) or other items a user might normally carry. A dust flap protects migration of makeup into the phone area. The door(s) can open from a variety of methods including hinged, sliding or rotating and be retained closed with magnets or snaps. The opening of the door may also activate an integrated light or alarm.

### CROSS REFERENCE TO RELATED APPLICATIONS

This application is a continuation-in-part of applicant's co-pending application Ser. No. 61/289,591 filed Dec. 23, 2009, Ser. No. 61/289,591 filed Dec. 23, 2009, 61/318,665 filed Mar. 29, 2010 and Ser. No. 29/339,652 filed Aug. 7, 2009, now D624,304 issued Sep. 28, 2010 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a cell phone or PDA carrying case. More particularly, the present cell phone or PDA carrying protective case allows all or major functions of the phone or PDA to be utilized while the phone or PDA is secured within the protective case and also allows for storage of personal items and further provides all the functions of a make-up compact.

2. Description of Related Art Including Information Disclosed Under 37 CFR 1.97 and 1.98.

A growing majority of people carry a cell phone with them on a regular basis when they are out of the home. For women they also carry make-up and some form of identification and credit/ATM card or money. A soft sided cell phone protective cases offer a pouch for a cell phone and a separate compartment for storing money, cards or the like. These cases require the user to remove the cell phone from the case to access the phone. They further provide limited space for storage of personal items and the personal items can shift as the case is moved.

A number of patents have been issued that provide for holding cell phones or other personal paraphernalia. Exemplary examples of patents that have been issued that try to address this problem are identified and discussed below.

U.S. Patent Number D517,311 issued Mar. 21, 2006 to Chang-Ho Kim, D543,023 issued May 22, 2007 to Kyung-Jin Han et al., D561,463 issued Feb. 12, 2008 to Rohit Malhotra and D515,807 issued Feb. 28, 2006 to Gabriel Faillace disclose cell phone cases. All of these patents disclose just a closure or case for a cell phone. While each of these patents discloses a container for the protection of a cell phone they do not include a compartment for makeup or storage of other personal items.

U.S. Pat. No. 6,164,451 issued Dec. 26, 2000 to Patricia McEvoy Sherman discloses a cosmetic case. The cosmetic case is only for the purposes of containing cosmetic items. This patent does not disclose the inclusion of a cell phone or for the storage of money or credit cards.

U.S. Pat. No. 7,293,635 issued Nov. 13, 2007 to Mary E. Repke et al., and U.S. Publication 2006/0011687 that was published on Jan. 19, 2006 to Alexander D. Wadley et al both disclose travel bags or purses that include compartments for storing a variety of items. These patents and published applications disclose a typical multi-functional bar or purse with various compartments. The compartment for the phone is for storage of the phone and does not allow for use of the phone while it is stored within the bag or purse. These patent documents also do not include for an integrated make-up holder.

U.S. Publication 2001/0035444 published on Nov. 1, 2001 to Joshua M. Alis discloses a cell phone holder with a storage compartment for holding money, credit cards or the like. This application is for a soft sided cell phone holder where the cell phone must be removed from the holder to dial and use the cell phone. This application further does not include makeup or a changeable makeup compartment.

D482,162 was issued on Nov. 11, 2003 to Jean-Michael Bostroem discloses a makeup apparatus. This makeup apparatus provides the specific and only purpose of holding makeup for the user to apply. There is no disclosure for the inclusion of a cell phone or for storing money or other items.

What is needed is a cell phone case that allows for full functioning of a cell phone while the cell phone is installed within the case. The ideal cell phone case further includes interchangeable trays for money, credit cards, makeup and the like. The proposed cell phone or PDA compact case satisfies these needs.

### BRIEF SUMMARY OF THE INVENTION

It is an object of the cell phone or PDA compact case for the case to allow for the use of all of the phone's functions while the cell phone or PDA is secured within the case. The case is rigid in nature and provides protection of the cell phone that is stored within. The cell phone or PDA is preferably slightly press-fit into the case to prevent movement within the case. In a preferred embodiment the case is configured for a specific device such as an Apple Computer iPhone, the case can be configured to fit a generic size or shaped phone where the control buttons can be accessed while the phone or PDA is secured within the case. The phone or PDA is mounted with rigid bumpers that conform around the device to grasp, cushion and sandwich the cell phone or PDA.

It is an object of the cell phone or PDA compact case for the case to include one or a variety of door opening configurations. This door configuration can include but not be limited to swinging with one or multiple doors or hinges, sliding from one or more sides and pivoting. The door may be held shut with a snap, magnet or clip to prevent accidental opening of the door. The door may further include a reflective surface or mirror to aid in the application of makeup or other functions.

It is another object of the cell phone or PDA compact case for the case to include interchangeable trays. These interchangeable trays are snapped, slid or otherwise secured within the case. These trays offer significant versatility to the owner. In particular the interchangeable trays may be for different makeup colors depending upon the use and the time of day that the user will need the makeup. When the tray includes makeup, a dust flap covers some or the entire tray to prevent migration of makeup into the phone area. Other trays can include storage of pills, car keys, credit card(s) or money. The retention of flexible or movable items such as money or credit cards can be held within the protective case with the use of elastic band(s) and or metal springs or fingers to reduce movement of these devised within the case.

It is still another object of the cell phone or PDA compact case for the case to include additional functionality to the case. This functionality may include a light that is illuminated when the door is opened to provide lighting of the interior of the case or to the surrounding area. The opening of the door may further be accompanied by a temporal or continuous alarm that sounds when the case is opened to notify the owner.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the compact case for a cell phone or PDA.

FIG. 2 shows an exploded isometric view of the cell phone or PDA compact case showing a sandwich construction.

FIG. 3 shows an isometric view of the cell phone or PDA case with various inserts.

FIG. 4 shows a perspective view of a corner of the case.

FIG. 5 shows a perspective view of the case with a slide bottom housing closure.

FIG. 6 shows a perspective view of the case with a rotating bottom housing closure.

FIG. 7 shows a perspective view of the case with dual hinged doors.

FIG. 8 shows a back view of the compact case for a cell phone or PDA with a kickstand shown in an open position.

FIG. 9 shows a side view of the compact case for a cell phone or PDA with the kickstand in an open position.

### DETAILED DESCRIPTION OF THE INVENTION

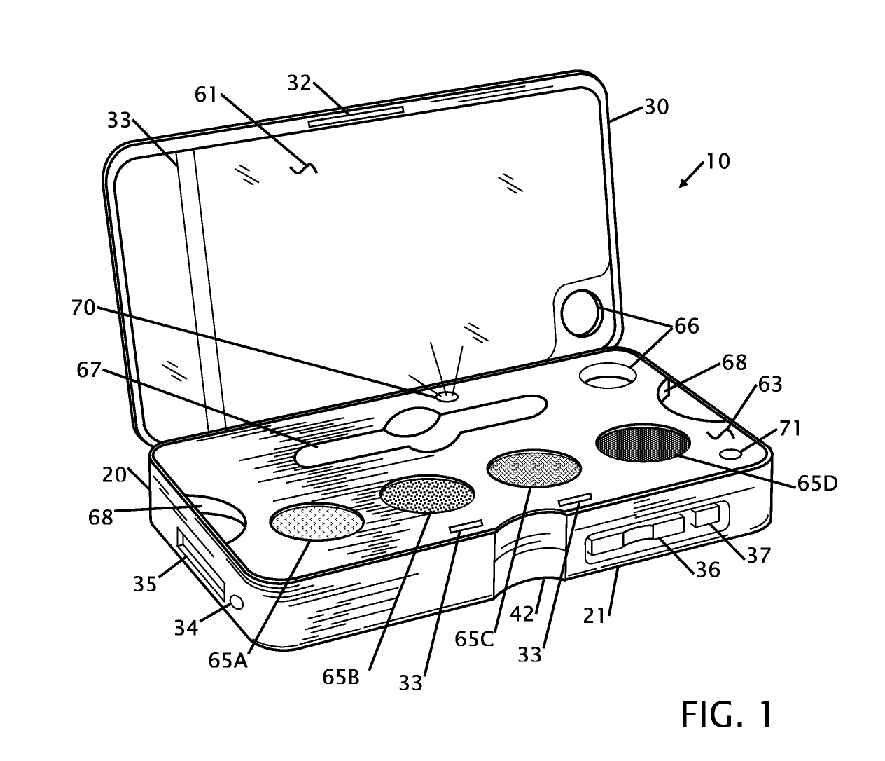

FIG. 1 shows a perspective view of the compact case for a cell phone or PDA. In this embodiment the compact case 10 has a front housing 20 having an essentially planar front face 21. It is contemplated that the front face can include a skin or scratch cover to protect the front of the phone or PDA that is inserted within the compact case 10.

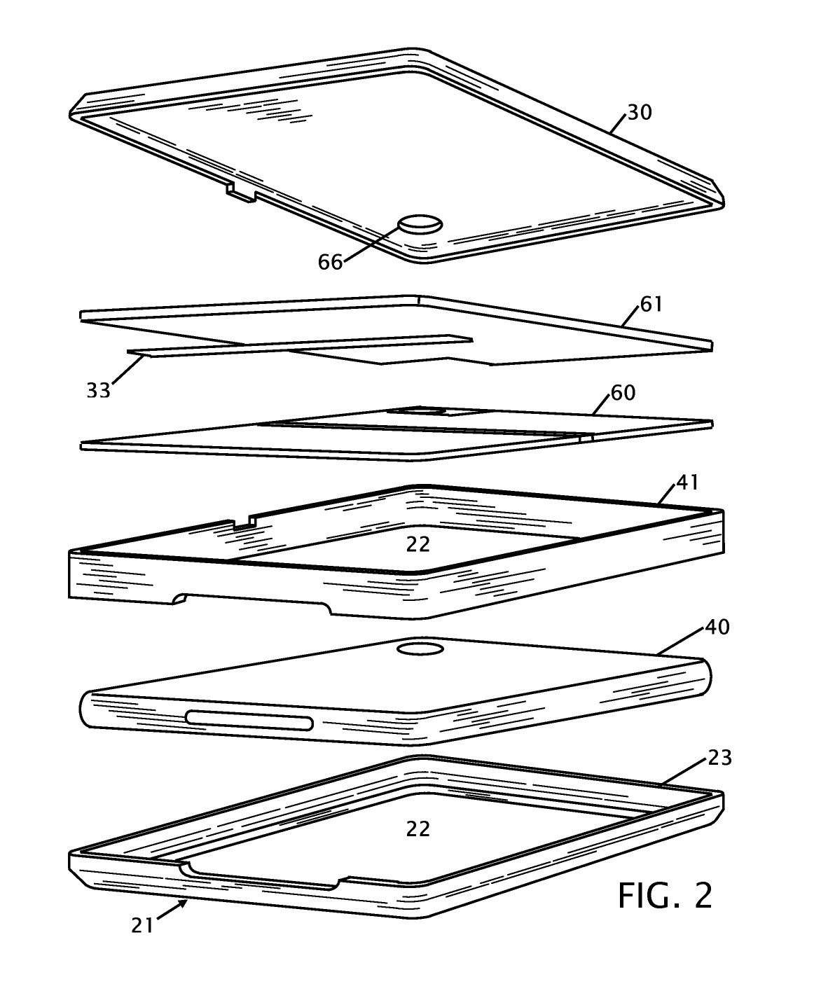

FIG. 2 shows an exploded isometric view of the cell phone or PDA compact case showing a sandwich construction. The interior cavity 22 of the front housing sufficiently sized to accept a cell phone 40. The front face 21 of the housing has an opening sized to provide access to the display screen of a cell phone 40 and further having an external lip 23 that extends essentially vertical from the essentially planar face. The compact has a back housing 30 that engages into the front housing 23 to close the cell phone 40 within the front 23 and the back housing 30. In the embodiment shown in FIG. 2, an additional shell ring 41 is used to provide addition storage capacity. The shell ring 41 can be configured at a variety of heights to accommodate one or a plurality of inserts 60.

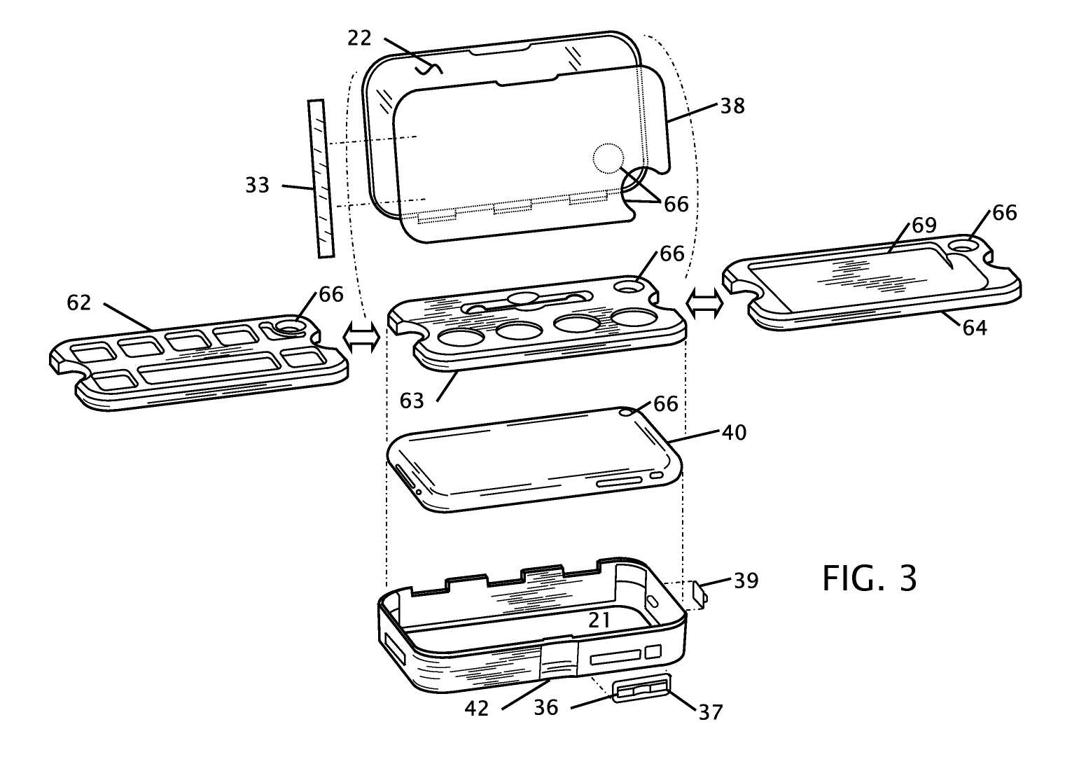

FIG. 3 shows an isometric view of the cell phone or PDA case with various inserts 60. The interior cavity 22 includes a spacing to accept changeable trays 62, 63 and 64 located behind the cell phone 40. In this figure three different interchangeable inserts are shown. The inserts shown include but are not limited to a pill insert 62. The pill insert 62 is shown with seven different openings, one for each day of the week. It is contemplated that the pill insert can take a number of embodiments. In one contemplated embodiment the pill insert can have as many as 31 pockets to accommodate a pill for each day of the week. In another contemplated embodiment the pill insert can have the appearance of one or more clocks where the pill(s) are placed in positions that correspond to the time of day when each pill is to be taken.

Insert 64 is configured with a pocket 69 for holding money, credit cards, receipts or other documents that can easily be concealed within the compact case.

The middle changeable tray 63 is configured for make-up. Referring back to FIG. 1 shows an enlarged view of the make-up tray 63 in the case 10. The front housing 20 has a finger clearance slot 42 to make it easier for an owner to lift and hinge open the back housing 30 from the front housing 20. In this figure the changeable tray 63 has four pockets 65A, 65B, 65C and 65D where each pocket can contain a different color of make-up or make-up for different areas of the face. The tray can have as few as one to many compartments depending upon the make-up requirement, and may further include a pocket for a sponge and or brush to apply the make-up. This insert 63 has a pocket 67 for a make-up application brush. This insert and others further have finger openings 68 for easier removal of the insert 63. A shield 38 provides a protective cover to hold any make-up in the tray and reduce migration of any make-up onto the mirror and or into the phone.

All of the inserts and the back housing 30 have an opening 66 for the camera of the cell phone or PDA. In the preferred embodiment, the back door is held shut with one or more neodymium magnet(s) 32 that attracts to one or more metal strip(s) 33. This preferred embodiment shows a light 70 that is illuminated when the back door is opened. It is further contemplated that a light sensor 71 can be included that will determine the need for the light 70 be illuminated based upon ambient light. A reed switch operates with the neodymium magnet 32 to operate the light 70. The back housing 30 has an integrated or a removable mirror 61 so a person can view themselves when they are applying make-up. An elastic band or metal spring 33 retains cards, money or loose papers.

The housing is configured to allow full access to all of the functions of the cell phone or PDA. In this embodiment, an iPhone made and trademarked by Apple computer Inc., is shown and described, but other phones or PDA's are contemplated to allow the phone or PDA to be used while the phone is enclosed in the rigid compact case. The opening for the camera 66 exists out the back of the compact case. Openings for an ear plug 34 and the power connection 35 exists at one end of the housing. Inserts extensions are used to operate the volume 36, lock 39, and mute 37, camera function and other controls. While the embodiment shown fits one or a similarly size and shaped family of cell phones, PDAs, MP3 or movie players the shell is made to easily accommodate different size and shaped devices.

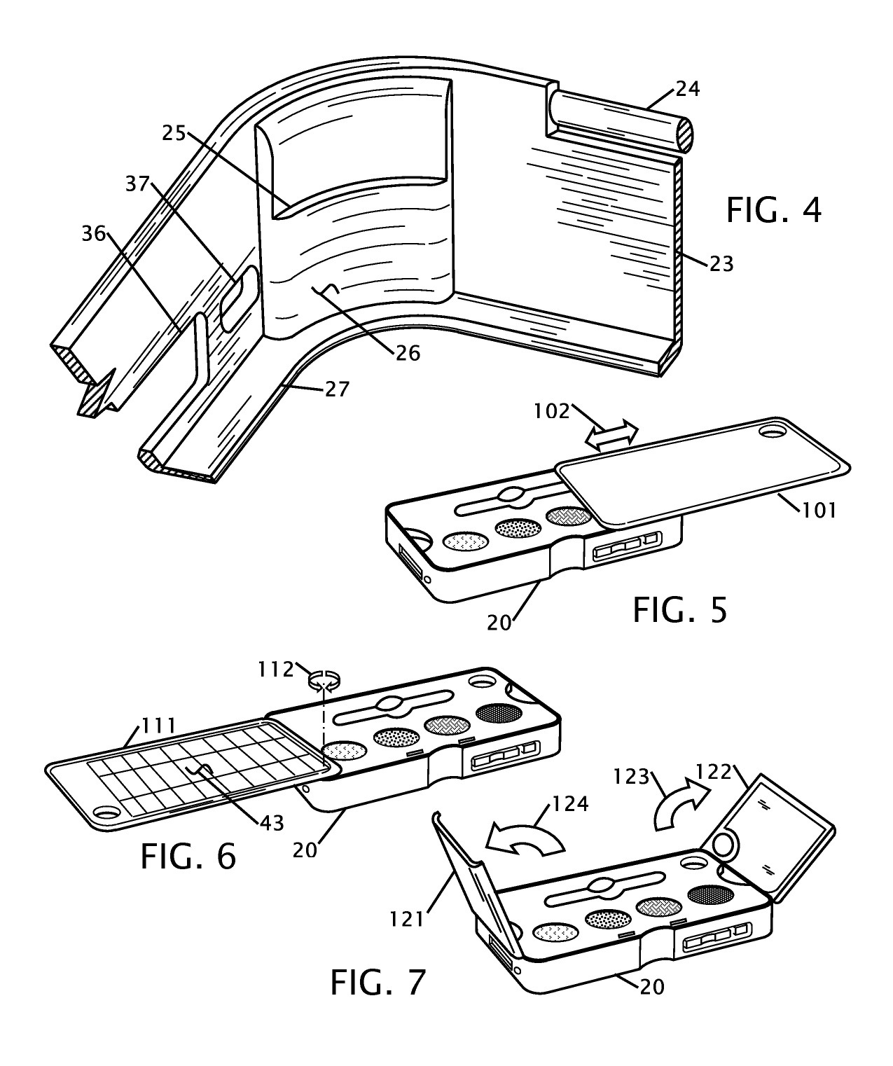

FIG. 4 shows a perspective view of a corner of the case that shows how the case accommodates a tight fit for the cell phones, PDAs, MP3 or movie player. In this figure, the locating mechanism is shown. In the preferred embodiment, a compliant elastomeric insert is inserted or over molded into the front housing case 20. The elastomeric material forms a face flange 27 to cushion and seal the front of the phone or PDA. Each corner has a press-in-wall that cushions and positions the inserted device. The elastomeric insert further includes a tray stop 25 that vertically locates and positions the interchangeable trays. In this figure, a portion of one of the hinge pins 24 is shown as well as openings for the mute 37 and volume control 36 extensions that fit through the external lip 23.

Referring back to FIG. 2, a multi-leaved hinge is shown. While a multi-interleaved hinge is shown a simple one leave hinge is also contemplated. Other hinge and back door opening methods are contemplated, shown and described in FIGS. 5, 6 and 7.

FIG. 5 shows a perspective view of the case with a slide bottom housing closure. The back housing 101, in this embodiment, slides 102 on the front housing 100. It is contemplated that the back housing 101 slides in dovetail tracks, but other methods are contemplated that provide equivalent operation.

FIG. 6 shows a perspective view of the case with a rotating bottom housing closure. The back housing 111, in this embodiment, rotates 112 on pivotal axes to open and close the back of the compact case. The back cover of the case in this figure shows a solar cell 43 that can be electrically connected with the cell phone to provide a continuous charge when the cell phone is placed in light.

FIG. 7 shows a perspective view of the case with dual hinged doors. The back housing has two doors 121 and 122 that hinge and open 123, 124 to provide access to the interior compact make-up area.

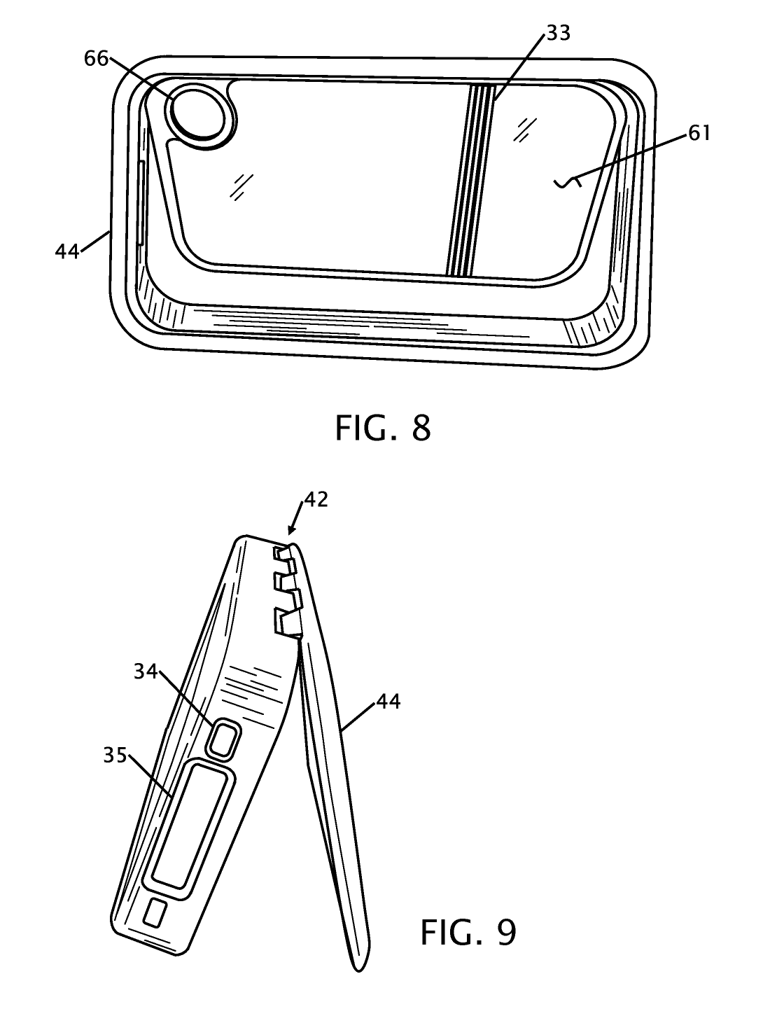

FIG. 8 shows a back view of the compact case for a cell phone or PDA with a kickstand shown in an open position. In this figure the cell phone has been removed to show that the outer housing 44 hinges on the back cover to provide a kick stand for the cell phone or PDA case. The back cover shows a mirrored surface 61 with a clip, retainer 33 or band to retain money, credit cards or loose items. The opening for the camera 66 is visible from this figure.

FIG. 9 shows a side view of the compact case for a cell phone or PDA with the kickstand 44 in an open position on hinges 42. This side view shows the opening for the power connection 35 and the ear plug connection 34.

Thus, specific embodiments of a cell phone or PDA compact case have been disclosed. It should be apparent, however, to those skilled in the art that many more modifications besides those described are possible without departing from the inventive concepts herein. The inventive subject matter, therefore, is not to be restricted except in the spirit of the appended claims.

1. A cell phone protective case comprising:
a front housing having an essentially planar front face with an opening sized to provide access to a display screen of a cell phone and further having an external lip that extends essentially vertical from said essentially planar front face;
an interior cavity of said front housing sufficiently sized to accept said cell phone;
a back housing that engages into said front housing to close said cell phone within said front and said back housing, and
a said interior cavity includes a spacing to accept a changeable tray located between said cell phone and said back housing.

2. The cell phone protective case according to claim 1 wherein the tray is accommodates make-up, pills or identification information and money.

3. The cell phone protective case according to claim 1 that further includes a dust flap.

4. The cell phone protective case according to claim 1 wherein said phone mounting is for an iPhone.

5. The cell phone protective case according to claim 1 that further includes elastomeric pads for securely holding of said cell phone.

6. The cell phone protective case according to claim 1 that further includes a shell ring to increase a plurality of changeable trays that can be inserted.

7. The cell phone protective case according to claim 1 wherein said back housing hinges on said front housing.

8. The cell phone protective case according to claim 1 wherein said back housing slides on said front housing.

9. The cell phone protective case according to claim 1 wherein said back housing rotates on said front housing.

10. The cell phone protective case according to claim 1 wherein said back housing further includes a solar collector.

11. The cell phone protective case according to claim 1 that further includes an illumination device that is operated when said back housing is opened.

12. The cell phone protective case according to claim 1 that further includes an elastic band or metal spring to hold paper, money or credit cards within said back housing.

13. The cell phone protective case according to claim 1 that further includes at least one magnet to hold said back housing closed.

14. The cell phone protective case according to claim 1 that further includes a scratch cover over said essentially planar front face.

15. The cell phone protective case according to claim 1 that further includes an alarm that sounds when said back housing is opened.

16. The cell phone protective case according to claim 1 wherein said back housing can be used as a kickstand.

17. The cell phone protective case according to claim 1 wherein said front housing and said back housing is made from plastic or metal.

18. The cell phone protective case according to claim 1 wherein said back housing further includes a mirror.

19. The cell phone protective case according to claim 1 wherein said front back housing and or said back housing has opening for access to electrical connections to said cell phone.

20. The cell phone protective case according to claim 1 that further includes insert extensions to articulate mechanical button(s) on said cell phone.
